(19) United States
(12) Patent Application Publication
(10) Pub. No.: US 2025/0079499 A1
(43) Pub. Date: Mar. 6, 2025

(54) SOLID ELECTROLYTE MEMBRANE, PREPARATION METHOD THEREOF, AND ALL SOLID RECHARGEABLE BATTERIES

(71) Applicant: Samsung SDI Co., Ltd., Yongin-si (KR)

(72) Inventors: Mijung JUNG, Yongin-si (KR); Seonhyeok AN, Yongin-si (KR); Seunghyun OH, Yongin-si (KR)

(21) Appl. No.: 18/815,972

(22) Filed: Aug. 27, 2024

(30) Foreign Application Priority Data
Aug. 30, 2023 (KR) 10-2023-0114847

(51) Int. Cl. H01M 10/056

(52) U.S. Cl. CPC H01M 10/056; H01M 2300/0094

(57) ABSTRACT

A solid electrolyte membrane, a method of manufacturing the same, and an all-solid-state rechargeable battery, the solid electrolyte membrane includes a composite; and a solid electrolyte, wherein the composite includes a diamagnetic core particle; an insulating layer surrounding the diamagnetic core particle; and a shell surrounding the insulating layer, the shell including a solid electrolyte material.

### CROSS-REFERENCE TO RELATED APPLICATION

This application claims priority to and the benefit of Korean Patent Application No. 10-2023-0114847 filed in the Korean Intellectual Property Office on Aug. 30, 2023, the entire contents of which are incorporated herein by reference.

### BACKGROUND

### 1. Field

Embodiments relate to solid electrolyte membranes, methods of manufacturing the same, and all-solid-state rechargeable batteries including the same.

### 2. Description of the Related Art

Development of batteries with high energy density and safety has been actively being made in response to industrial demands. For example, lithium ion batteries have been available in the automobile fields as well as the information-related device and communication device fields.

### SUMMARY

The embodiments may be realized by providing a solid electrolyte membrane including a composite; and a solid electrolyte, wherein the composite includes a diamagnetic core particle; an insulating layer surrounding the diamagnetic core particle; and a shell surrounding the insulating layer, the shell comprising a solid electrolyte material.

The diamagnetic core particle may have an aspect ratio, as calculated by Equation 1, of greater than about 1:

$$Aspect ratio = major axis length / minor axis length . \qquad [ Equation 1 ]$$

A major axis of the diamagnetic core particle may be arranged to be about 50° to about 130° with respect to a plane of the solid electrolyte membrane.

The diamagnetic core particle may be needle-shaped, plate-shaped, or oval-shaped.

The diamagnetic core particle may include a carbon material, and the carbon material may include artificial graphite, natural graphite, graphene, a carbon nanotube (CNT), an L-carbon nanotube (long length CNT), a carbon fiber, carbon black, or a combination thereof.

The insulating layer may include a polymer, the polymer including polyethylene oxide, a hydrogenated nitrile rubber, a styrene-butadiene rubber, polyvinylidene fluoride, or a combination thereof.

A weight ratio of the diamagnetic core particle and the insulating layer may be about 1:0.01 to about 1:50.

The solid electrolyte material of the shell may include a sulfide solid electrolyte material, an oxide solid electrolyte material, a halide solid electrolyte material, or a combination thereof.

A weight ratio of the diamagnetic core particle and the shell may be about 1:1 to about 1:500.

A major axis length of the diamagnetic core particle may be about 1 μm to about 50 μm and a minor axis length of the diamagnetic core particle may be about 0.01 μm to about 5 μm.

The composite may be included in the solid electrolyte membrane in an amount of about 0.1 wt % to about 5 wt %, based on a total weight of the solid electrolyte membrane.

The solid electrolyte of the solid electrolyte membrane may include a sulfide solid electrolyte, an oxide solid electrolyte, a halide solid electrolyte, or a combination thereof, may be in a form of particles, and may have an average particle diameter (D₅₀) of about 0.1 μm to about 5.0 μm.

The embodiments may be realized by providing a method of preparing a solid electrolyte membrane, the method including obtaining a composite that includes a diamagnetic core particle, an insulating layer surrounding the diamagnetic core particle, and a shell surrounding the insulating layer, the shell comprising a solid electrolyte, preparing a slurry for forming an electrolyte membrane such that the slurry for forming an electrolyte membrane comprises the composite and a solid electrolyte, and coating the slurry for forming the electrolyte membrane on a substrate.

The method may further include applying a magnetic field to the slurry for forming an electrolyte membrane coated on the substrate.

A strength of the magnetic field may be about 0.1 T to about 3 T, and an application time of the magnetic field may be about 0.1 second to about 10 minutes.

The method may further include drying the slurry for forming an electrolyte membrane after the magnetic field is applied to form the solid electrolyte membrane.

Obtaining the composite may include mixing diamagnetic particles and an insulating material in a first solvent followed by performing a first drying, mixing a resultant of the first drying and a solid electrolyte raw material in a second solvent followed by performing a second drying, and heat treating the resultant of the second drying.

The slurry for forming the solid electrolyte membrane may be prepared by mixing the composite, a solid electrolyte, and a third solvent.

The first drying may be performed at about 80° C. to about 150° C.

The second drying may be performed at about 80° C. to about 150° C.

The heat treatment may be performed at about 200° C. to about 600° C.

The embodiments may be realized by providing an all-solid-state rechargeable battery including a positive electrode layer; a negative electrode layer; and the solid electrolyte membrane according to an embodiment between the positive electrode layer and the negative electrode layer.

### BRIEF DESCRIPTION OF THE DRAWINGS

Features will become apparent to those of skill in the art by describing in detail exemplary embodiments with reference to the attached drawings in which:

FIGS. 1 and 2 are schematic cross-sectional views of composites according to some embodiments.

FIG. 3 is a schematic view of a solid electrolyte membrane according to some embodiments.

FIG. 4 is a schematic perspective view of a solid electrolyte membrane according to some embodiments.

FIG. 5 is a schematic cross-sectional view of a solid electrolyte membrane according to some embodiments.

FIGS. 6 and 7 are schematic cross-sectional views of all-solid-state rechargeable battery according to some embodiments.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In addition, it will also be understood that when a layer is referred to as being “between” two layers, it can be the only layer between the two layers, or one or more intervening layers may also be present.

Hereinafter, embodiments will be described in detail so that those of ordinary skill in the art can easily implement them. However, this disclosure may be embodied in many different forms and is not construed as limited to the example embodiments set forth herein.

The terminology used herein is used to describe embodiments only, and is not intended to limit the present disclosure. The singular expression includes the plural expression unless the context clearly dictates otherwise.

As used herein, “combination thereof” means a mixture, a stack, a composite, a copolymer, an alloy, a blend, a reaction product, and the like of the constituents.

Herein, it should be understood that terms such as “comprises,” “includes,” or “have” are intended to designate the presence of an embodied feature, number, step, element, or a combination thereof, but it does not preclude the possibility of the presence or addition of one or more other features, number, step, element, or a combination thereof.

In the drawings, the thickness of layers, films, panels, regions, etc., may be exaggerated for clarity and like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

“Layer” includes not only a shape formed on the whole surface when viewed from a plan view, but also a shape formed on a partial surface.

“Particle diameter” or “average particle diameter” may be measured by a method well known to those skilled in the art, for example may be measured by a particle size analyzer, or may be measured by a transmission electron micrograph or a scanning electron micrograph. Alternatively, it is possible to obtain an average particle diameter value by measuring using a dynamic light scattering method, performing data analysis, counting the number of particles for each particle size range, and calculating from this. An average particle diameter may mean a diameter (D₅₀) of particles having a cumulative volume of 50 volume % in a particle size distribution. As used herein, when a definition is not otherwise provided, the average particle diameter means a diameter (D₅₀) of particles having a cumulative volume of 50 volume % in the particle size distribution that is obtained by measuring the size (diameter or major axis length) of about 20 particles at random in a scanning electron microscope image.

“Thickness” may be measured through photographs taken with an electron microscope, for example a scanning electron microscope.

Herein, “or” is not to be construed as an exclusive meaning, for example “A or B” is construed to include A, B, A+B, and the like.

“Metal” is interpreted as a concept including ordinary metals, transition metals and metalloids (semi-metals).

### Solid Electrolyte Membrane

Some embodiments provide a solid electrolyte membrane including a composite and a solid electrolyte. In an implementation, the composite may include a core including diamagnetic particles (e.g., diamagnetic core particles); an insulating layer surrounding the core; and a shell surrounding the insulating layer and including a solid electrolyte.

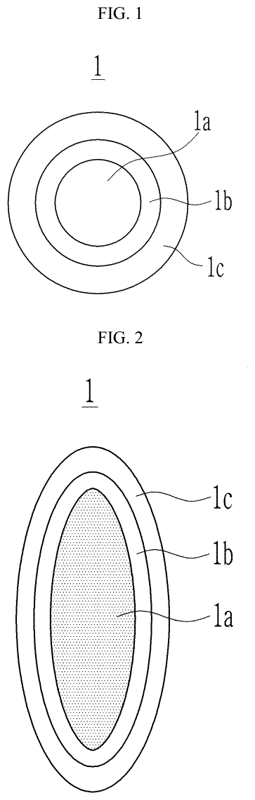

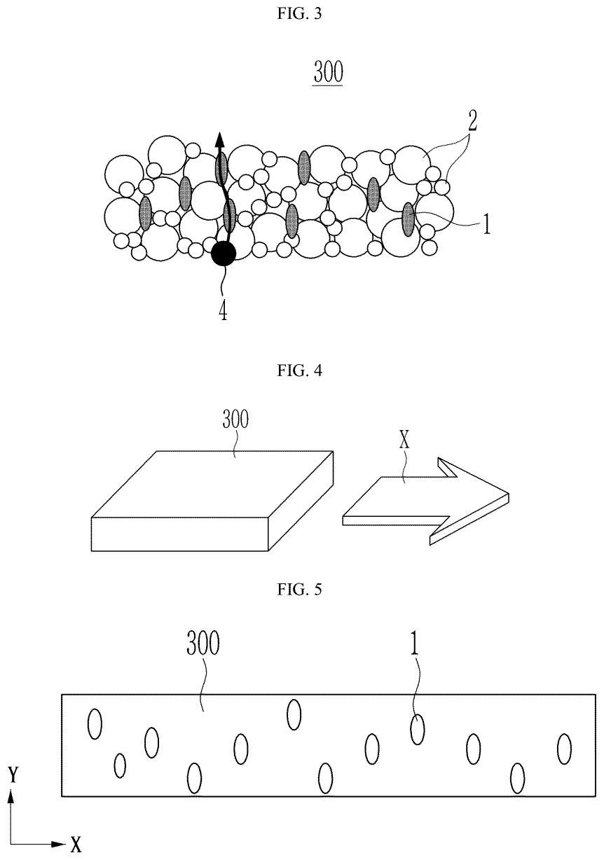

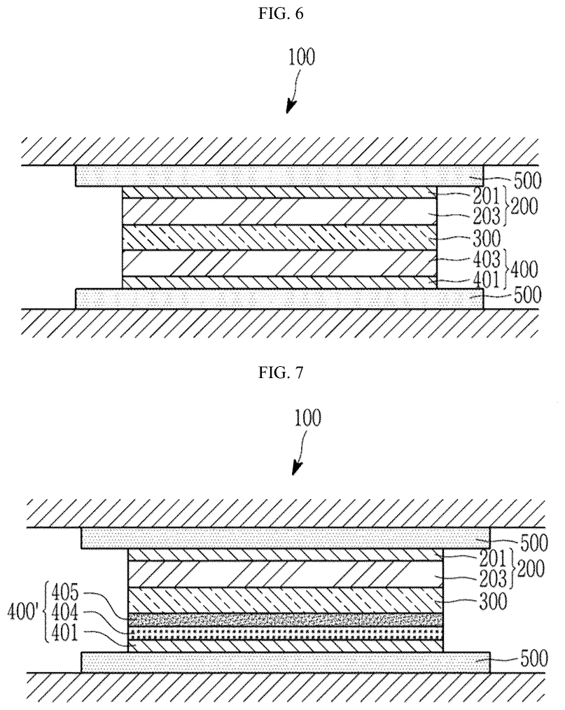

FIGS. 1 and 2 are schematic cross-sectional views of a composite 1 included in the solid electrolyte membrane 300 according to some embodiments, FIG. 3 is a schematic view of the solid electrolyte membrane 300 according to some embodiments, FIGS. 4 and 5 are a schematic perspective view and a cross-sectional view of the solid electrolyte membrane 300 according to some embodiments, and FIGS. 6 and 7 are schematic cross-sectional views of the all-solid-state rechargeable battery 100 including the solid electrolyte membrane 300 according to some embodiments.

All-solid-state rechargeable batteries use no flammable organic dispersive medium, and even if a short circuit were to occur, may greatly reduce possibility of fire or explosion and thus greatly increase safety, compared with lithium ion batteries that include a liquid electrolyte. A solid electrolyte may have lower lithium ionic conductivity than a liquid electrolyte. In order to shorten a movement path of ions in an electrode plate of the all-solid-state batteries, pores may be formed to fill the solid electrolyte therein or an additive increasing the lithium ionic conductivity may be added. However, forming the pores to fill the solid electrolyte therein may have a limit to tightly filling the solid electrolyte in the pores. Adding the additive to increase ionic conductivity could cause a side reaction between the solid electrolyte and the additive or affect properties of slurry for forming an electrode layer and thus the selection of the additive may be limited.

In order to shorten the movement path of lithium ions in the solid electrolyte membrane, a solid electrolyte itself may be composite having a core-shell structure, wherein the composite may include diamagnetic particles in the core and a solid electrolyte in the shell, in the solid electrolyte membrane. The composite having the core including diamagnetic particles itself may have electrical conductivity, and if used for the solid electrolyte membrane as it is, there could be a risk of internal short circuit of a cell. Accordingly, some embodiments may provide a solid electrolyte membrane including a composite capable of reducing the movement path of lithium ions as well as suppressing possibility of the internal short circuit of the cell.

According to some embodiments, the composite 1, as shown in FIGS. 1 to 3, in order to reduce a movement path of lithium ions 4 in the solid electrolyte membrane 300, may have a core-shell structure including a core 1a including diamagnetic particles and a shell 1c including a solid electrolyte. In addition, in order to help reduce the risk of the internal short circuit of the cell due to the core 1a including diamagnetic particles, an insulating layer surrounding the core 1b may be between the core 1a and the shell 1c. Through this, the movement path of lithium ions 4 may be shortened to help prevent the internal short circuit of the cell as well as secure ionic conductivity and high rate capability. In addition, the insulating layer 1b between the core 1a and the shell 1c may help suppress the internal short circuit of the cell without designing the solid electrolyte membrane 300 itself as a multilayer, which may make it possible to form a thinner solid electrolyte membrane and also, make the manufacturing process easier.

In an implementation, in order to further improve the ionic conductivity and high rate capability of the all-solid-state rechargeable battery, the composite itself may be non-spherical (e.g. oblong), as shown in FIG. 2, in the solid electrolyte membrane.

In an implementation, the composite in the solid electrolyte membrane may not only be non-spherical but also aligned in a perpendicular direction or close to the perpendicular direction to a plane direction of the solid electrolyte membrane. In a method of forming the solid electrolyte membrane 300 by coating a slurry for a solid electrolyte membrane including the aforementioned non-spherical composite on a substrate, the non-spherical composite may be randomly distributed in the solid electrolyte membrane 300. In an implementation, in order to align the non-spherical composite close to the perpendicular direction to the plane direction of the solid electrolyte membrane in the solid electrolyte membrane 300, a method of applying a magnetic field to the non-spherical composite, after coating the slurry for a solid electrolyte membrane including the non-spherical composite, may be performed. The composite alignment may be controlled by the magnetic field because the non-spherical composite has diamagnetic properties. In an implementation, as shown FIGS. 1 and 2, the composite 1 having the core 1a including non-spherical diamagnetic particles may be used to control the alignment of the composite 1 in the solid electrolyte membrane 300.

In an implementation, the aforementioned composite 1 may be aligned at or close to the perpendicular direction relative to the plane direction of the solid electrolyte membrane 300, the movement path of lithium ions in the solid electrolyte membrane may be shortened, and interfacial contact resistance among the solid electrolyte may be reduced. Accordingly, the all-solid-state rechargeable battery 100 including the solid electrolyte membrane 300 may exhibit an improved high rate capability as well as improved ionic conductivity.

Hereinafter, elements constituting the solid electrolyte membrane 300 according to some embodiments will be described in more detail.

### Composite

As shown in FIGS. 1 and 2, a composite 1 may include a core 1a including diamagnetic particles; an insulating layer 1b surrounding the core 1a; and a shell 1c surrounding the insulating layer and including a solid electrolyte. In an implementation, the composite 1 may have a core-shell structure and includes the core 1a including diamagnetic particles and the shell 1c including a solid electrolyte and simultaneously, the insulating layer 1b between the core 1a and the shell 1c.

In an implementation, in the composite 1, the core 1a (or the diamagnetic particles included in the core) may be non-spherical. The core 1a may have an aspect ratio of greater than about 1 according to Equation 1. Herein, in Equation 1, units of a major axis length and a minor axis length match each other.

$$Aspect ratio = major axis length / minor axis length \qquad [ Equation 1 ]$$

In Equation 1, the major axis length and the minor axis length are values for the core 1a. Such non-spherical diamagnetic particles and the composite 1 including the same may be aligned in a perpendicular direction or close to the perpendicular direction to a plane direction of the solid electrolyte membrane (e.g., at 50° to 130° with respect to the plane direction X of the solid electrolyte membrane 300) by a magnetic field externally applied thereto. In an implementation, the plane direction X of the solid electrolyte membrane 300 represents a parallel direction to the surface of a wide side of the solid electrolyte membrane. FIG. 4 shows a perspective view of the solid electrolyte membrane 300 and the plane direction X of the solid electrolyte membrane 300. In addition, FIG. 5 shows a cross-sectional view of the solid electrolyte membrane 300 in a thickness direction, and the plane direction X and a perpendicular direction Y to the plane direction X of the solid electrolyte membrane 300 are respectively drawn as a line.

The larger the aspect ratio represented by Equation 1, the more improved performance of the all-solid-state rechargeable battery including the solid electrolyte membrane according to some embodiments. In an implementation, the aspect ratio represented by Equation 1 may be greater than or equal to about 1.1, greater than or equal to about 1.2, greater than or equal to about 1.3, greater than or equal to about 1.5, greater than or equal to about 2, or greater than or equal to about 3. In an implementation, an upper limit of the aspect ratio represented by Equation 1 may be less than or equal to about 5,000, less than or equal to about 300, less than or equal to about 100, less than or equal to about 50, less than or equal to about 20, or less than or equal to about 10, considering convenience and cost savings in the manufacturing process. In an implementation, an aspect ratio of core 1a may be about 1.1 to about 20 or about 1.5 to about 10.

In an implementation, the major axis length of the composite may be about 1 μm to about 50 μm or the minor axis length of the composite may be about 0.01 μm to about 5 μm. In an implementation, the aspect ratio, which is a ratio of the major axis length to the length of the minor axis of the composite, may be greater than about 1.

In an implementation, the composite may be included in an amount of about 0.1 wt % to about 50 wt %, based on a total weight of the solid electrolyte membrane.

In an implementation, in the composite 1, the insulating layer 1b may have a uniform thickness or may be non-uniform. In an implementation, the shell 1c may also have a uniform thickness or may be non-uniform.

In an implementation, the composite 1 may satisfy Equation 2, Equation 3, or both Equations 2 and 3. Within these ranges, the composite 1 may be effectively aligned with its major axis in a direction perpendicular to or close to a perpendicular direction to the plane direction of the solid electrolyte membrane by an externally applied magnetic field. Herein, in Equations 2 and 3, the units of the numerator and denominator match each other to thus cancel out.

$$0.1 \leq {A}_{1} / C \leq 100 \qquad [ Equation 2 ]$$

$$0.01 \leq {A}_{2} / C \leq 10 \qquad [ Equation 3 ]$$

In Equations 2 and 3, A₁ represents a major axis length of the core 1a, A₂ represents a minor axis length of the core 1a, and C represents a thickness of the shell 1c.

In an implementation, the composite 1 may satisfy Equation 4. Accordingly, an alignment effect by the core 1a of the composite 1, an internal short-circuit suppression effect by the insulating layer 1b, and a lithium ion conduction effect by the shell 1c may be harmonized. Herein, in Equation 4, the units of the numerator and denominator match each other, and thus the units cancel out.

$$0.05 \leq {A}_{1} / ( B + C ) \leq 500 \qquad [ Equation 4 ]$$

In Equation 4, the definitions of A₁ and C are as described above, and B represents the thickness of the insulating layer 1b.

In an implementation, a major axis length of the core 1a may be about 1 μm to about 50 μm, about 1 μm to about 20 μm, about 2 μm to about 15 μm, or about 3 μm to about 12 μm. In an implementation, a minor axis length of the core 1a may be about 10 nm to about 5 μm, about 100 nm to about 5 μm, or about 1 μm to about 4 μm. In an implementation, a thickness of the shell 1c may be about 10 nm to about 10 μm, about 100 nm to about 5 μm, or about 1 μm to about 3 μm. A thickness of the insulating layer 1b may be about 10 nm to about 10 μm, about 100 nm to about 5 μm, or about 1 μm to about 3 μm. Within these ranges, an alignment effect by the core 1a, an internal short circuit suppression effect by the insulating layer 1b, and a lithium ion conduction effect by the shell 1c may be harmonized. In an implementation, the major axis length of the core 1a, the minor axis length of the core 1a, the thickness of the shell 1c, and the thickness of the insulating layer 1b mean average values. A method of measuring the major axis length of the core 1a, the minor axis length of the core 1a, the thickness of the shell 1c, and the thickness of the insulating layer 1b may include, e.g., obtaining a cross-section specimen by cutting the solid electrolyte membrane 300, as shown in FIG. 5, and taking an image capable of examining the composite 1 in the solid electrolyte membrane 300 with a scanning electron microscope (SEM). In an implementation, any ten composites 1 in one cross-section specimen may be measured with respect to a major axis length of each core 1a, a minor axis length of the core 1a, a thickness of each insulating layer 1b, and a thickness of each shell 1c, which are used to calculate each average value.

In an implementation, in the composite 1, a weight ratio of the core 1a and the shell 1c may be about 1:1 to about 1:500, about 1:2 to about 1:100, about 1:10 to about 1:50. Within these ranges, an alignment effect by the core 1a, an internal short circuit suppression effect by the insulating layer 1b, and a lithium ion conduction effect by the shell 1c may be harmonized.

In an implementation, in the solid electrolyte membrane 300, the major axis of the composite 1 may be aligned in the perpendicular direction Y or close to the direction Y to the plane direction X of the solid electrolyte membrane. An alignment angle of the major axis of the composite 1 with the plane direction X of the solid electrolyte membrane 300, as shown in FIG. 4, may be obtained by measuring an angle of the major axis of the composite 1 with the plane direction X, based on the plane direction X of the solid electrolyte membrane (in the cross-section of the solid electrolyte membrane 300, the plane direction of the solid electrolyte membrane is marked by a line as X of FIG. 5) in the cross-section of the solid electrolyte membrane 300.

In an implementation, the major axis of the composite 1 in the solid electrolyte membrane 300 may be aligned within a range of about 50° to about 130° with the plane direction X of the solid electrolyte membrane 300, about 70° to about 110°, about 85° to about 95°, or substantially, perpendicular (90)°, which is the direction Y. Within the ranges, the movement path of lithium ions is shortened in the solid electrolyte membrane, and interfacial contact resistance may be reduced among the solid electrolyte.

In an implementation, in the composite 1, the diamagnetic particles of the core 1a may have a suitable shape, e.g., the core 1a may have a non-spherical shape satisfying greater than about 1 of an aspect ratio represented by Equation 1. In an implementation, the core 1a may include diamagnetic particles that are needle-shaped, sheet-shaped, or oval-shaped. In an implementation, the core 1a may include a carbon material, e.g., artificial graphite, natural graphite, graphene, carbon nanotube (CNT), carbon fiber, carbon black, or a combination thereof, e.g., as diamagnetic particles.

In an implementation, the insulating layer 1b may include an insulating material. As the insulating material, a suitable material having insulating properties may be used. In an implementation, the insulating material may include a polymer, e.g., polyethylene oxide (PEO), a hydrogenated nitrile butadiene rubber (HNBR), a styrene-butadiene rubber (SBR), and polyvinylidene fluoride (PVDF), or a combination thereof. In an implementation, the polymer may be included in the insulating layer 1b, and it is possible to effectively suppress internal short circuit of the all-solid-state rechargeable battery while ensuring the alignment effect of the core 1c of the composite 1.

In an implementation, in the composite 1, a weight ratio of the core and the insulating layer may be about 1:0.01 to about 1:50, or about 1:0.01 to about 1:10, about 1:0.05 to about 1:5, or about 1:0.08 to about 1:1. Within these ranges, the alignment effect by the core and the effect of suppressing the occurrence of internal short circuit by the insulating layer can be harmonized.

In an implementation, in the composite 1, the shell 1c may include a suitable solid electrolyte. In an implementation, the shell may include a solid electrolyte, e.g., a sulfide solid electrolyte, an oxide solid electrolyte, a halide solid electrolyte, or a combination thereof, and the description described below may be equally applicable thereto.

In an implementation, the solid electrolyte included in the shell 1c may include a sulfide solid electrolyte, and the shell 1c of the composite 1 may include Li₆PS₅Cl, a type of argyrodite-type sulfide solid electrolyte.

In an implementation, the content of the composite 1 may be about 0.1 wt % to about 50 wt %, about 0.5 wt % to about 20 wt %, or about 1 wt % to about 10 wt %, based on a total weight of the solid electrolyte membrane 300. Within these ranges, the effect of improving ionic conductivity and high rate capability according to the composite 1 can be further enhanced.

### Solid Electrolyte

The solid electrolyte membrane 300 may include a solid electrolyte 2 in addition to the composite 1. The solid electrolyte membrane may include a solid electrolyte, and ionic conductivity of the solid electrolyte membrane can be secured. The solid electrolyte may include a sulfide solid electrolyte, an oxide solid electrolyte, a halide solid electrolyte, or a combination thereof. The aforementioned solid electrolyte is explained below.

### Sulfide Solid Electrolyte

In an implementation, the sulfide solid electrolyte may include Li₂S—P₂S₅, Li₂S—P₂S₅—LiX (wherein X is a halogen element, for example I, or Cl), Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCI, Li₂S—SiS₂—B₂S₃—LiI, Li₂S—SiS₂—P₂S₅—LiI, Li₂S—B₂S₃, Li₂S—P₂S₅-ZmSn (wherein m and n are each an integer and Z is Ge, Zn, or Ga), Li₂S—GeS₂, Li₂S—SiS₂—Li₃PO₄, Li₂S—SiS₂-LiₚMO_{q} (wherein p and q are integers and M is P, Si, Ge, B, Al, Ga, or In), or a combination thereof.

In an implementation, the sulfide solid electrolyte may be obtained by, e.g., mixing Li₂S and P₂S₅ in a molar ratio of about 50:50 to about 90:10 or about 50:50 to about 80:20 and optionally performing heat-treatment. Within the above mixing ratio ranges, a sulfide solid electrolyte having excellent ionic conductivity may be prepared. The ionic conductivity may be further improved by adding SiS₂, GeS₂, B₂S₃, or the like as other components thereto.

Mechanical milling or a solution method may be applied as a mixing method of sulfur-containing raw materials for preparing a sulfide solid electrolyte. The mechanical milling is a method of mixing the starting materials into fine particles by placing them in a ball mill reactor and agitating them strongly. The solution method may be performed by mixing the starting materials in a solvent to obtain a solid electrolyte as a precipitate. In an implementation, in the case of heat-treatment after mixing, crystals of the solid electrolyte may be more robust and ionic conductivity may be improved. In an implementation, the sulfide solid electrolyte may be prepared by mixing sulfur-containing raw materials and performing heat treatment two or more times. In this case, a sulfide solid electrolyte having high ionic conductivity and robustness may be prepared.

The sulfide solid electrolyte particles according to some embodiments may be, e.g., prepared through a first heat treatment of mixing sulfur-containing raw materials and firing at about 120° C. to about 350° C. and a second heat treatment of mixing the resultant of the first heat treatment and firing the same at about 350° C. to about 800° C. The first heat treatment and the second heat treatment may be performed under an inert gas or nitrogen atmosphere, respectively. The first heat treatment may be performed for about 1 hour to about 10 hours and the second heat treatment may be performed for about 5 hours to about 20 hours. Small raw materials may be milled through the first heat treatment, and a final solid electrolyte can be synthesized through the second heat treatment. Through such two or more heat treatments, a sulfide solid electrolyte having high ionic conductivity and high performance can be obtained, and such a solid electrolyte may be suitable for mass production. A temperature of the first heat treatment may be for example about 150° C. to about 330° C. or about 200° C. to about 300° C. and a temperature of the second heat treatment may be for example about 380° C. to about 700° C., or about 400° C. to about 600° C.

In an implementation, the sulfide solid electrolyte particles may include argyrodite-type sulfide. The argyrodite-type sulfide solid electrolyte particle may have high ionic conductivity close to the range of about 10-4 to about 10-2 S/cm, which is the ionic conductivity of some liquid electrolytes at room temperature, and may form an intimate bond between the positive electrode active material and the solid electrolyte without causing a decrease in ionic conductivity, and furthermore, an intimate interface between the electrode layer and the solid electrolyte membrane. An all-solid-state rechargeable battery including the same may have improved battery performance such as rate capability, coulombic efficiency, and cycle-life characteristics.

The argyrodite-type sulfide solid electrolyte particle may include, e.g., a compound represented by Chemical Formula 11.

(LiₐM¹_{b}M²_{c})(P_{d}M³ₑ)(S_{f}M⁴_{g})Xₕ [Chemical Formula 11]

In Chemical Formula 11, 4≤a≤8, M¹ may be Mg, Cu, Ag, or a combination thereof, 0≤b<0.5, M² may be Na, K, or a combination thereof, 0≤c<0.5, M³ may be Sn, Zn, Si, Sb, Ge, or a combination thereof, 0<d<4, 0≤e<1, M⁴ may be O, SOₙ, or a combination thereof, 1.5≤n<5, 3≤f≤12, 0<g<2, X may be F, Cl, Br, I, or a combination thereof, and 0≤h≤2.

In an implementation, in Chemical Formula 11, a halide element (X) may be included, and in this case, it may be expressed as 0<h≤2. In an implementation, M¹ element may be included in Chemical Formula 11, and in this case, it may be expressed as 0<b<0.5. In Chemical Formula 11, M³ may be understood as an element substituted for P and may be 0<e<1. In Chemical Formula 11, M⁴ may be substituted for S and, e.g., may be 0<g<2, and f, a ratio of S, may be, e.g., 3≤f<7. In an implementation, M⁴ may be SOₙ, and SOₙ may be, e.g., S₄O₆, S₃O₆, S₂O₃, S₂O₄, S₂O₅, S₂O₆, S₂O₇, S₂O₈, SO₄, SO₅, or SO₄.

In an implementation, in Chemical Formula 11, a+b+c+h=7, d+e=1, and f+g+h=6.

In an implementation, the argyrodite-type sulfide solid electrolyte particles may include Li₃PS₄, Li₂P₃S₁₁, Li₂PS₆, Li₆PS₅Cl, Li₆PS₅Br, Li_{5.8}PS_{4.8}Cl_{1.2}, Li_{6.2}PS_{5.2}Br_{0.8}, Li_{5.75}PS_{4.75}Cl_{1.25}, (Li_{5.69}Cu_{0.06})PS_{4.75}Cl_{1.25}, (Li_{5.72}Cu_{0.03})PS_{4.75}Cl_{1.25}, (Li_{5.69}Cu_{0.06})P(S_{4.70}(SO₄)_{0.05})Cl_{1.25}, (Li_{5.69}Cu_{0.06})P(S_{4.60}(SO₄)_{0.15})Cl_{1.25}, (Li_{5.72}Cu_{0.03})P(S_{4.725}(SO₄)_{0.025})Cl_{1.25}, (Li_{5.72}Na_{0.03})P(S_{4.725}(SO₄)_{0.025})Cl_{1.25}, Li_{5.75}P(S_{4.725}(SO₄)_{0.025})Cl_{1.25}, or a combination thereof.

The argyrodite-type sulfide solid electrolyte may be prepared, e.g., by mixing lithium sulfide and phosphorus sulfide, and optionally lithium halide. Heat treatment may be performed after mixing them. The heat treatment may include, e.g., two or more heat treatment processes. The method of preparing the argyrodite-type sulfide solid electrolyte may include, e.g., a first heat treatment in which raw materials are mixed and fired at about 120° C. to about 350° C., and a second heat treatment in which the resultant of the first heat treatment is mixed again and fired at about 350° C. to about 800° C.

An average particle diameter (D₅₀) of the sulfide solid electrolyte particle, e.g., may be about 0.1 μm to about 5.0 μm, about 0.1 μm to about 3.0 μm, small particles of about 0.1 μm to about 1.9 μm, or large particles of about 2.0 μm to about 5.0 μm. The sulfide solid electrolyte particles may be a mixture of small particles having an average particle diameter of about 0.1 μm to about 1.9 μm and large particles having an average particle diameter of about 2.0 μm to about 5.0 μm. The average particle diameter of the sulfide solid electrolyte particles may be measured using an electron microscope image, e.g., a particle size distribution may be obtained by measuring the size (diameter or major axis length) of 20 particles in a scanning electron microscope image, and D₅₀ may be calculated therefrom.

### Oxide Solid Electrolyte

The oxide solid electrolyte may include, e.g., Li₁₊ₓTi₂₋ₓAl(PO₄)₃(LTAP) (0≤x<4), Li_{1+x+y}AlₓTi₂₋ₓSi_{y}P_{3-y}O₁₂(0<x<2, 0≤y<3), BaTiO₃, Pb(Zr,Ti) O₃(PZT), Pb₁₋ₓLaₓZr_{1-y}Ti_{y}O₃(PLZT) (0≤x<1, 0≤y<1), PB(Mg₃Nb_{2/3}) O₃—PbTiO₃(PMN-PT), HfO₂, SrTiO₃, SnO₂, CeO₂, NazO, MgO, NiO, CaO, BaO, ZnO, ZrO₂, Y₂O₃, Al₂O₃, TiO₂, SiO2, lithium phosphate (Li₃PO₄), lithium titanium phosphate (LiₓTi_{y}(PO₄)₃, 0<x<2, 0<y<3), Li_{1+x+y}(Al, Ga)ₓ(Ti, Ge)₂₋ₓSi_{y}P_{3-y}O₁₂(0≤x≤1, 0≤y≤1), lithium lanthanum titanate (LiₓLa_{y}TiO₃, 0<x<2, 0<y<3), Li₂O, LiAlO₂, Li₂O—Al₂O₃—SiO₂—P₂O₅—TiO₂—GeO₂ ceramics, Garnet ceramics Li₃₊ₓLa₃M₂O₁₂(wherein M=Te, Nb, or Zr; x is an integer of 1 to 10), or a mixture thereof.

### Halide Solid Electrolyte

The solid electrolyte membrane may include, e.g., the halide solid electrolyte. The halide solid electrolyte may contain a halogen element as a main component, meaning that the ratio of the halide element to all elements constituting the solid electrolyte may be greater than or equal to about 50 mol %, greater than or equal to about 70 mol %, greater than or equal to about 90 mol %, or about 100 mol %. In an implementation, the halide solid electrolyte may not contain a sulfur element.

The halide solid electrolyte may contain a lithium element, metal element other than lithium, and the halogen element. The metal element other than lithium may be Al, As, B, Bi, Ca, Cd, Co, Cr, Fe, Ga, Hf, In, Mg, Mn, Ni, Sb, Sc, Sn, Ta, Ti, Y, Zn, Zr, or a combination thereof. The halogen element may be F, Cl, Br, I, or a combination thereof, e.g., Cl, Br, or a combination thereof. The halide solid electrolyte, e.g., may be represented by LiₐM₁X₆(M is Al, As, B, Bi, Ca, Cd, Co, Cr, Fe, Ga, Hf, In, Mg, Mn, Ni, Sb, Sc, Sn, Ta, Ti, Y, Zn, Zr, or a combination thereof, X is F, Cl, Br, I, or a combination thereof, and 2≤a≤3). The halide solid electrolyte may include, e.g., Li₂ZrCl₆, Li_{2.7}Y_{0.7}Zr_{0.3}Cl₆, Li_{2.5} Y_{0.5}Zr_{0.5}Cl₆, Li_{2.5}In_{0.5}Zr_{0.5}Cl₆, Li₂In_{0.5}Zr_{0.5}Cl₆, Li₃YBr₆, Li₃YCl₆, Li₃YBr₂Cl₄, Li₃YbCl₆, Li_{2.6}Hf_{0.4} Yb_{0.6}Cl₆, or a combination thereof.

The solid electrolyte 2 included in the solid electrolyte membrane 300 may be the same as or different from the solid electrolyte included in the shell 1c of the composite 1. In an implementation, the solid electrolyte 2 included in the shell 1c of the composite 1 and the solid electrolyte membrane 300 may each include an argyrodite-type sulfide solid electrolyte.

A content of the solid electrolyte 2 included in the solid electrolyte membrane 300 (excluding the solid electrolyte included in the shell 1c of the composite 1) may be about 50 wt % to about 99.9 wt %, e.g., about 80 wt % to about 99.9 wt %, about 90 wt % to about 99.5 wt %, about 95 wt % to about 98 wt %, or about 96 wt % to about 97 wt %, based on a total weight of the solid electrolyte membrane 300.

The solid electrolyte 2 included in the solid electrolyte membrane 300 may be in a form of particles and its average particle diameter (D₅₀) may be about 0.1 μm to about 5.0 μm, about 0.5 μm to about 5.0 μm, about 0.5 μm to about 4.0 μm, about 0.5 μm to about 3.0 μm, about 0.5 μm to about 2.0 μm, or about 0.5 μm to about 1.0 μm. The average particle diameter of the solid electrolyte particles may be measured using a SEM image, and for example, a particle size distribution may be obtained by measuring the size (diameter or major axis length) of 20 particles in a SEM image, and D₅₀ may be calculated therefrom.

### Binder

In an implementation, the solid electrolyte membrane may further include a binder as an optional component. The binder may serve to adhere the composite 1 particles and solid electrolyte 2 particles to each other. Such a binder may include, e.g., a nitrile-butadiene rubber, a hydrogenated nitrile-butadiene rubber, a styrene-butadiene rubber, an acrylated styrene-butadiene rubber, an acrylonitrile-butadiene rubber, an acrylic rubber, a butyl rubber, a fluorine rubber, a natural rubber, polydimethylsiloxane, polyethylene oxide, polyvinylpyrrolidone, polyvinylpyridine, chlorosulfonated polyethylene, polyvinyl alcohol, polytetrafluoroethylene, polyvinylidene fluoride, a polyvinylidene fluoride-hexafluoro propylene copolymer, polyvinyl chloride, carboxylated polyvinyl chloride, polyvinyl fluoride, polyethylene, a polypropylene, an ethylene-propylene copolymer, an ethylene-propylene-diene copolymer, polyamideimide, polyimide, an acrylic resin, poly(meth)acrylate, polyacrylonitrile, polystyrene, polyurethane, a copolymer thereof, or a combination thereof.

The binder may be included in an amount of about 0.1 wt % to about 3 wt %, for example about 0.5 wt % to about 2 wt %, about 0.5 wt % to about 1.5 wt %, based on a total weight of the solid electrolyte membrane 300. Within the above ranges, the components in the solid electrolyte membrane may be well combined without reducing the ionic conductivity of the solid electrolyte, thereby improving durability and reliability of the battery.

### Other Components

In an implementation, the solid electrolyte membrane may optionally further include other components, e.g., an alkali metal salt, an ionic liquid, or a conductive polymer.

In an implementation, the alkali metal salt may be a lithium salt. A concentration of the lithium salt in the solid electrolyte membrane may be greater than or equal to about 1 M, e.g., about 1 M to about 4 M. In this case, the lithium salt may be improve ionic conductivity by improving lithium ion mobility in the solid electrolyte membrane.

The lithium salt may be a suitable lithium salt, e.g., LiPF₆, LiBF₄, LiSbF₆, LiAsF₆, LiClO₄, LiAlO₂, LiAlCl₄, LiPO₂F₂, LiCl, LiI, LISCN, LIN (CN)₂, lithium bis(oxalato) borate (LiBOB), lithium difluoro (oxalato) borate (LiDFOB), lithium difluorobis(oxalato)phosphate (LiDFBP), lithium bis(trifluoromethanesulfonyl)imide (LiTFSI), lithium bis(fluoro) sulfonyl)imide (LiFSI), lithium bis(pentafluoroethanesulfonyl)imide (LiBETI), lithium trifluoromethane sulfonate, lithium tetrafluoroethane sulfonate, or a combination thereof.

In an implementation, the lithium salt may be an imide lithium salt, e.g., LiTFSI, LiFSI, LiBETI, or a combination thereof. The imide lithium salt may maintain or improve ionic conductivity by appropriately maintaining chemical reactivity with the ionic liquid.

The ionic liquid has a melting point below room temperature, so it is in a liquid state at room temperature and refers to a salt or room temperature molten salt composed of ions alone.

The ionic liquid may be a compound including a cation, e.g., ammonium, pyrrolidinium, pyridinium, pyrimidinium, imidazolium, piperidinium, pyrazolium, oxazolium, pyridazinium, phosphonium, sulfonium, triazolium, or a mixture thereof, and an anion, e.g., BF₄⁻, PF₆⁻, AsF₆⁻, SbF₆⁻, AlCl₄⁻, HSO₄⁻, ClO₄⁻, CH₃SO₃⁻, CF₃CO₂⁻, Cl⁻, Br⁻, I⁻, BF₄⁻, SO₄⁻, CF₃SO₃⁻, (FSO₂)₂N⁻, (C₂F₅SO₂)₂N⁻, (C₂F₅SO₂)(CF₃SO₂)N⁻, or (CF₃SO₂)₂N⁻.

The ionic liquid may be, e.g., N-methyl-N-propylpyrrolidinium bis(trifluoromethanesulfonyl)imide, N-butyl-N-methylpyrrolidium bis(3-trifluoromethylsulfonyl)imide, 1-butyl-3-methylimidazolium bis(trifluoromethylsulfonyl)amide, or 1-ethyl-3-methylimidazolium bis(trifluoromethylsulfonyl)amide.

A weight ratio of the solid electrolyte and the ionic liquid in the solid electrolyte membrane may be about 0.1:99.9 to about 90:10, for example about 10:90 to about 90:10, about 20:80 to about 90:10, about 30:70 to about 90:10, about 40:60 to about 90:10, or about 50:50 to about 90:10. The solid electrolyte membrane satisfying the above ranges may maintain or improve ionic conductivity by improving the electrochemical contact area with the electrode. In an implementation, the energy density, discharge capacity, rate capability, etc. of the all-solid-state rechargeable battery may be improved.

### Manufacturing Method of Solid Electrolyte Membrane

In an implementation, a method of preparing a solid electrolyte membrane may include obtaining a composite that includes a core including diamagnetic particles, an insulating layer surrounding the core, and a shell surrounding the insulating layer and including a solid electrolyte, preparing a slurry for forming an electrolyte membrane including the composite and a solid electrolyte, and coating the slurry for forming the electrolyte membrane on a substrate. The aforementioned descriptions are about a method of manufacturing a solid electrolyte membrane, which is some embodiments. Hereinafter, repeated descriptions that overlap with the aforementioned contents may be omitted, and the process of manufacturing a solid electrolyte membrane, which is some embodiments, will be described in more detail.

The composite may be obtained by mixing diamagnetic particles and an insulating material in a first solvent followed by first drying, mixing the resultant of the first drying and the solid electrolyte raw material in a second solvent, followed by second drying, and heat treating the resultant of the second drying.

In an implementation, an addition ratio of the diamagnetic particles and the insulating material by weight may be about 1:0.01 to about 1:50, or about 1:0.01 to about 1:10, about 1:0.05 to about 1:5, or about 1:0.08 to about 1:1.

The first solvent may be a solvent that disperses the diamagnetic particles and the insulating material, and the second solvent may be a solvent that can disperse the obtained product and the solid electrolyte raw material. In an implementation, an organic solvent such as N-methyl-2-pyrrolidone (NMP) may be used as the first solvent and acetonitrile may be used as the second solvent.

In an implementation, the first drying and the second drying, e.g., may be performed at about 80° C. to about 150° C., about 90° C. to about 140° C., or about 100° C. to about 130° C. In an implementation, the heat treatment, e.g., may be performed at about 200° C. to about 600° C., about 250° C. to about 550° C., about 300° C. to about 500° C., or about 350° C. to about 450° C. In an implementation, the temperatures of the first drying and the second drying may be the same or different from each other.

The composite 1 may be obtained by this method, and the structure of composite 1 thus obtained is as described above.

Subsequently, a slurry for forming an electrolyte membrane including the composite and solid electrolyte may be prepared. The slurry for forming the electrolyte membrane may be prepared by mixing the composite, solid electrolyte, and a third solvent.

The third solvent may be a suitable solvent that can disperse the composite and the solid electrolyte. Examples of the third solvent may include octyl acetate, isobutyryl isobutyrate, xylene, toluene, benzene, hexane, or a combination thereof.

In an implementation, during preparation of the slurry for forming the electrolyte membrane, one or more components, e.g., the binder, alkali metal salt, ionic liquid, and conductive polymer that are described above as components that can be included in the solid electrolyte membrane may be further included. In an implementation, suitable dispersants (e.g., H—NBR, etc.) may be further added.

The aforementioned slurry for forming an electrolyte membrane may be coated on a substrate by a suitable method. In an implementation, methods such as bar coating, spin coating, die coating, transfer coating, or spray coating may be used. Herein, suitable materials may be used as the base material.

In an implementation, the method may further include applying a magnetic field to the slurry for forming an electrolyte membrane coated on the substrate. Accordingly, the composite 1, which was randomly distributed within the solid electrolyte membrane 300, may be aligned in the direction perpendicular (Y) or close to the perpendicular direction with respect to the plane direction (X) of the solid electrolyte membrane 300.

In an implementation, the strength of the magnetic field may be about 0.1 T (Tesla) to about 3 T, or about 0.5 T to about 2 T and the application time of the magnetic field may be about 0.1 second to about 10 minutes. The temperature at which the magnetic field is applied may be a suitable temperature, and the higher the temperature, the weaker the magnetic field strength may be. By appropriately controlling the strength and application time of the magnetic field, the alignment of the composite within the solid electrolyte membrane by applying the magnetic field may be more effectively secured.

In an implementation, after applying the magnetic field, the method may include drying the slurry for forming an electrolyte membrane to which the magnetic field has been applied to form a solid electrolyte membrane. In an implementation, drying and compressing may be further included after application of the magnetic field.

In an implementation, it may further include drying the slurry for forming an electrolyte membrane to which a magnetic field is applied, forming a solid electrolyte membrane on the substrate, and compressing the solid electrolyte membrane, wherein conditions such as drying and compressing may follow what is commonly known in the technical field. In an implementation, it may further include removing the substrate as needed after application of the magnetic field.

### All-Solid-State Rechargeable Battery

In an implementation, an all-solid-state rechargeable battery including a positive electrode layer; a negative electrode layer; and the aforementioned solid electrolyte membrane between the positive electrode layer and the negative electrode layer is provided. The all-solid-state rechargeable battery may include the solid electrolyte membrane according to the aforementioned embodiment, and it may effectively suppress internal short circuit of the cell while exhibiting excellent ionic conductivity and high rate capability.

Hereinafter, repeated descriptions that overlap with the above may be omitted, and the components of an all-solid-state rechargeable battery according to some embodiments, will be described in more detail with reference to FIG. 6.

The all-solid-state rechargeable battery may be expressed as an all-solid-state battery or an all-solid rechargeable lithium battery.

FIG. 6 is a cross-sectional view of an all-solid-state battery according to some embodiments. Referring to FIG. 6, the all-solid-state rechargeable battery 100 may include an electrode assembly in which a negative electrode layer 400 including a negative electrode current collector 401 and a negative electrode active material layer 403, a solid electrolyte membrane 300, and a positive electrode layer 200 including a positive electrode current collector 201 and a positive electrode active material layer 203 are stacked in a case such as a pouch. In an implementation, the all-solid-state rechargeable battery 100 may further include an elastic layer 500 outside at least one of the positive electrode layer 200 and the negative electrode layer 400. In an implementation, as illustrated in FIG. 6, one electrode assembly may include a negative electrode layer 400, a solid electrolyte membrane 300, and a positive electrode layer 200, or an all-solid-state battery can also be manufactured by stacking two or more electrode assemblies.

### Positive Electrode Layer

The positive electrode layer may include, e.g., a positive electrode current collector 201 and the positive electrode active material layer 203 on the positive electrode current collector 201.

The positive electrode current collector 201 may include an aluminum foil, a nickel foil, a stainless steel foil, a titanium foil, nickel foam, copper foam, a polymer substrate coated with a conductive metal, or a combination thereof. In an implementation, aluminum foil may be used as the positive electrode current collector.

The positive electrode active material layer 203 may include positive electrode active material, and may optionally include the solid electrolyte, the binder, or conductive material.

As the positive electrode active material, a compound capable of reversible intercalation and deintercalation of lithium (lithiated intercalation compound) may be used. In an implementation, a composite oxide of a metal, e.g., cobalt, manganese, nickel, or a combination thereof, and lithium may be used.

The composite oxide may be a lithium transition metal composite oxide, e.g., lithium nickel oxide, lithium cobalt oxide, lithium manganese oxide, lithium iron phosphate compound, cobalt-free nickel-manganese oxide, and lithium-excessive layered oxide, or a combination thereof. In an implementation, the positive electrode active material may be a high nickel positive electrode active material having a nickel content of greater than or equal to about 80 mol % based on 100 mol % of a metal excluding lithium in the lithium transition metal composite oxide. A content of nickel in the high nickel positive electrode active material may be greater than or equal to about 85 mol %, greater than or equal to about 90 mol %, greater than or equal to about 91 mol %, or greater than or equal to about 94 mol % and less than or equal to about 99 mol % based on 100 mol % of a metal excluding lithium. The high-nickel positive electrode active materials may achieve high capacity and may be applied to high-capacity, high-density rechargeable lithium batteries.

In an implementation, a compound represented by one of the following chemical formulas may be used. LiₐA_{1-b}X_{b}O_{2-c}D′_{c}(0.90≤a≤1.8, 0<b≤0.5, 0<c≤0.05); LiₐMn_{2-b}X_{b}O_{4-c}D′_{c}(0.90≤a≤1.8, 0≤b≤0.5, 0<c<0.05); LiₐNi_{1-b-c}CO_{b}X_{c}O_{2-α}D′_{α} (0.90≤a≤1.8, 0≤b≤0.5, 0≤c≤0.5, 0<α<2); LiₐNi_{1-b-c}Mn_{b}X_{c}O_{2-α}D′_{α} (0.90≤a≤ 1.8, 0≤b≤0.5, 0≤c≤0.5, 0<α<2); LiₐNi_{b}Co_{c}L¹_{d}GₑO₂(0.90≤a≤1.8, 0≤b≤0.9, 0≤ c≤0.5, 0≤d≤0.5, 0≤e≤0.1); LiₐNiG_{b}O₂(0.90≤a≤1.8, 0.001≤b≤0.1); LiₐCoG_{b}O₂ (0.90≤a≤1.8, 0.001≤b≤0.1); LiₐMn_{1-b}G_{b}O₂(0.90≤a≤1.8, 0.001≤b≤0.1); LiₐMn₂G_{b}O₄(0.90≤a≤1.8, 0.001≤b≤0.1); LiₐMn_{1-g}G_{g}PO₄(0.90≤a≤1.8, 0≤g≤ 0.5); Li_{(3-f)}Fe₂(PO₄)₃(0≤f≤2); LiₐFePO₄(0.90≤a≤1.8).

In the above chemical formulas, A may be Ni, Co, Mn, or a combination thereof; X may be Al, Ni, Co, Mn, Cr, Fe, Mg, Sr, V, a rare earth element, or a combination thereof; D′ may be O, F, S, P, or a combination thereof; G may be Al, Cr, Mn, Fe, Mg, La, Ce, Sr, V, or a combination thereof; and L¹ may be Mn, Al, or a combination thereof.

The positive electrode active material may include, e.g., lithium nickel oxide represented by Chemical Formula 21, lithium cobalt oxide represented by Chemical Formula 22, a lithium iron phosphate compound represented by Chemical Formula 23, cobalt-free lithium nickel-manganese oxide represented by Chemical Formula 24, or a combination thereof.

Liₐ₁Niₓ₁M¹_{y1}M²_{z1}O_{2-b1}X_{b1} [Chemical Formula 21]

In Chemical Formula 21, 0.9≤a1≤1.8, 0.3≤x1≤1,0≤y1≤0.7, 0≤z1≤0.7, 0.9≤x1+y1+z1≤1.1, 0≤b1<0.1, M¹ and M² may each independently be Al, B, Ba, Ca, Ce, Co, Cr, Cu, Fe, Mg, Mn, Mo, Nb, Si, Sn, Sr, Ti, V, W, or Zr, and X may be F, P, or S.

In Chemical Formula 21, 0.6≤x1≤1, 0≤y1≤0.4, and 0≤z1≤0.4 or 0.8≤x1≤1, 0≤y1≤0.2, and 0≤z1≤0.2.

Liₐ₂Coₓ₂M³_{y2}O_{2-b2}X_{b2} [Chemical Formula 22]

In Chemical Formula 22, 0.9≤a2≤1.8, 0.7≤x2≤1, 0≤y2≤0.3, 0.9≤x2+y2≤1.1, and 0≤b2≤0.1, M³ may be Al, B, Ba, Ca, Ce, Cr, Cu, Fe, Mg, Mn, Mo, Ni, Se, Si, Sn, Sr, Ti, V, W, Y, Zn, or Zr, and X may be F, P, or S.

Liₐ₃Feₓ₃M⁴_{y3}PO_{4-b3}X_{b3} [Chemical Formula 23]

In Chemical Formula 23, 0.95a3≤1.8, 0.6≤x3≤1, 0≤y3<0.4, 0≤b3≤0.1, M⁴ may be Al, B, Ba, Ca, Ce, Co, Cr, Cu, Mg, Mn, Mo, Ni, Se, Si, Sn, Sr, Ti, V, W, Y, Zn, and Zr, or Zr, and X may be F, P, or S.

Liₐ₄Niₓ₄Mn_{y4}M⁵_{z4}O_{2-b4}X_{b4} [Chemical Formula 24]

In Chemical Formula 24, 0.9≤a2≤1.8, 0.8≤x4<1, 0<y4<0.2, 0≤z4≤0.2, 0.9≤x4+y4+z4≤1.1, 0≤b4<0.1, M⁵ may be Al, B, Ba, Ca, Ce, Cr, Fe, Mg, Mo, Nb, Si, Sn, Sr, Ti, V, W, or Zr, and X may be F, P, or S.

An average particle diameter (D₅₀) of the positive electrode active material may be about 1 μm to about 25 μm, for example about 3 μm to about 25 μm, about 1 μm to about 20 μm, about 1 μm to about 18 μm, about 3 μm to about 15 μm, or about 5 μm to about 15 μm. In an implementation, the positive electrode active material may include small particles having an average particle diameter (D₅₀) of about 1 μm to about 9 μm and large particles having an average particle diameter (D₅₀) of about 10 μm to about 25 μm. The positive electrode active material having these particle size ranges may be harmoniously mixed with other components within the positive electrode active material layer and may achieve high capacity and high energy density. Herein, the average particle diameter means a diameter (D₅₀) of particles having a cumulative volume of 50 volume % in the particle size distribution that is obtained by measuring the size (diameter or major axis length) of 20 particles at random in a scanning electron microscope image for positive electrode active materials.

The positive electrode active material may be in the form of secondary particles made by agglomerating a plurality of primary particles or in the form of single particles. In an implementation, the positive electrode active material may have a spherical or close to spherical shape, or may have a polyhedral or irregular shape.

In an implementation, the positive electrode active material may include a buffer layer on the particle surface. The buffer layer may be expressed as a coating layer, a protective layer, or the like, and may help lower the interfacial resistance between the positive electrode active material and the sulfide solid electrolyte particles. In an implementation, the buffer layer may include lithium-metal-oxide, and the metal may be Al, B, Ca, Ce, Cr, Fe, Mg, Mo, Nb, Si, Sn, Sr, Ta, V, W, or Zr. The lithium-metal-oxide may help improve the performance of the positive electrode active material by facilitating the movement of lithium ions and electronic conduction, and may be improved for lowering the interfacial resistance between the positive electrode active material and solid electrolyte particles.

The positive electrode active material may be included within a suitable content range. In an implementation, the positive electrode active material may be included in an amount of about 55 wt % to about 99 wt %, e.g., about 65 wt % to about 95 wt %, or about 75 wt % to about 91 wt %, based on a total weight of the positive electrode active material layer.

### Binder

The binder may serve to adhere the positive electrode active material particles to each other and also to adhere the positive electrode active material to the positive electrode current collector 201. In an implementation, the binder may include polyvinyl alcohol, carboxymethyl cellulose, hydroxypropyl cellulose, diacetyl cellulose, polyvinyl chloride, carboxylated polyvinyl chloride, polyvinyl fluoride, a polymer including ethylene oxide, polyvinylpyrrolidone, polyurethane, polytetrafluoroethylene, polyvinylidene fluoride, polyethylene, polypropylene, styrene-butadiene rubber, a (meth)acrylated styrene-butadiene rubber, polyacrylonitrile, polymethyl methacrylate, a vinylidene fluoride/hexafluoropropylene copolymer, an epoxy resin, a (meth)acrylic resin, a polyester resin, or nylon.

### Conductive Material

The conductive material may be included to provide electrode conductivity and a suitable electrically conductive material that does not cause a chemical change may be used. Examples of the conductive material may include a carbon material such as natural graphite, artificial graphite, carbon black, acetylene black, ketjen black, a carbon fiber, a carbon nanofiber, a carbon nanotube, and the like; a metal material of a metal powder or a metal fiber including copper, nickel, aluminum, silver, and the like; a conductive polymer such as a polyphenylene derivative; or a mixture thereof.

A content of the binder and the conductive material may each independently be about 0.1 wt % to about 10 wt % and about 0.1 wt % to about 5 wt %, based on a total weight of the positive electrode active material layer 203.

The positive electrode active material layer 203 may further include an additive, e.g., fillers, coating agents, dispersants, or ionic conductivity auxiliary agents in addition to the positive electrode active material, the binder, and the conductive material. The fillers, coating agents, dispersants, ionic conductive auxiliary agents, may include suitable materials used in a positive electrode of all-solid-state rechargeable batteries.

### Solid Electrolyte

In an implementation, the positive electrode active material layer 203 may selectively include the solid electrolyte. The solid electrolyte may include, e.g., a sulfide solid electrolyte, an oxide solid electrolyte, a halide solid electrolyte, or a combination thereof, and the specific descriptions thereof may be the same as the above descriptions in the solid electrolyte membrane 300. In an implementation, the positive electrode active material layer 203 may further include a sulfide solid electrolyte, and the ionic conductivity of the positive electrode layer can be further improved.

The solid electrolyte included in the positive electrode active material layer 203 may be the same as the solid electrolyte included in the shell 1b of the aforementioned composite 1 or the solid electrolyte included in the solid electrolyte membrane 300. In an implementation, the shell 1b of the composite 1 may be composed of Li₆PS₅Cl, and the sulfide solid electrolyte included in the positive electrode active material layer 203 may also be composed of Li₆PS₅Cl.

In the positive electrode active material layer 203, a content of the solid electrolyte may be about 0.5 wt % to about 30 wt %, e.g., about 1 wt % to about 5 wt % based on a total weight of the positive electrode active material layer 203. Including the solid electrolyte in the positive electrode active material layer 203 within these amounts may help ensure that the efficiency and cycle-life characteristics of the all-solid-state rechargeable battery may be improved without reducing the capacity.

### Negative Electrode Layer

The negative electrode layer 400 may include, e.g., the negative electrode current collector 401 and the negative electrode active material layer 403 on the negative electrode current collector 401. The negative electrode active material layer 403 may include a negative electrode active material and may further include a binder, a conductive material, or a solid electrolyte.

The negative electrode active material may include a material that reversibly intercalates/deintercalates lithium ions, a lithium metal, a lithium metal alloy, a material capable of doping/dedoping lithium, or transition metal oxide.

The material that reversibly intercalates/deintercalates lithium ions may include, e.g., crystalline carbon, amorphous carbon, or a combination thereof as a carbon negative electrode active material. The crystalline carbon may be irregular, or sheet, flake, spherical, or fiber shaped natural graphite or artificial graphite. The amorphous carbon may be a soft carbon, a hard carbon, a mesophase pitch carbonization product, calcined coke, and the like.

The lithium metal alloy may include an alloy of lithium and a metal, e.g., Na, K, Rb, Cs, Fr, Be, Mg, Ca, Sr, Si, Sb, Pb, In, Zn, Ba, Ra, Ge, Al, or Sn.

The material capable of doping/dedoping lithium may be a Si negative electrode active material or a Sn negative electrode active material. The Si negative electrode active material may include silicon, a silicon-carbon composite, SiOₓ(0<x<2), a Si-Q alloy (wherein Q is an alkali metal, an alkaline-earth metal, a Group 13 element, a Group 14 element, a Group 15 element, a Group 16 element, a transition metal, a rare earth element, and a combination thereof, but not Si) and the Sn negative electrode active material may include Sn, SnO₂, a Sn—R alloy (wherein R is an alkali metal, an alkaline-earth metal, a Group 13 element, a Group 14 element, a Group 15 element, a Group 16 element, a transition metal, a rare earth element, and a combination thereof, but not Sn). At least one of these materials may be mixed with SiO₂. The elements Q and R may include Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, TI, Ge, P, As, Sb, Bi, S, Se, Te, Po, or a combination thereof.

The silicon-carbon composite may be, e.g., a silicon-carbon composite including a core including crystalline carbon and silicon particles and an amorphous carbon coating layer disposed on the surface of the core. The crystalline carbon may be artificial graphite, natural graphite, or a combination thereof. As the amorphous carbon precursor, coal pitch, mesophase pitch, petroleum pitch, coal oil, petroleum heavy oil, or polymer resin such as phenol resin, furan resin, or polyimide resin may be used. Herein, a content of silicon may be about 10 wt % to about 50 wt % based on a total weight of the silicon-carbon composite. In an implementation, the content of crystalline carbon may be about 10 wt % to about 70 wt % based on a total weight of the silicon-carbon composite and the content of amorphous carbon may be about 20 wt % to about 40 wt % based on a total weight of the silicon-carbon composite. In an implementation, a thickness of the amorphous carbon coating layer may be about 5 nm to about 100 nm.

An average particle diameter (D₅₀) of the silicon particle may be about 10 nm to about 20 μm, e.g., about 10 nm to about 500 nm. The silicon particles may be present in an oxidized form, and an atomic content ratio of Si:O in the silicon particle indicating a degree of oxidation may be 9 about 9:1 to about 33:67. The silicon particles may be SiOₓ particles, and in this case, the range of x in SiOₓ may be greater than 0 and less than 2. The average particle diameter (D₅₀) may be measured by a microscope image or a particle size analyzer, and may mean a diameter (D₅₀) of particles having a cumulative volume of 50 volume % in a particle size distribution.

The Si negative electrode active material or Sn negative electrode active material may be mixed with the carbon negative electrode active material. A mixing ratio of the Si negative electrode active material or Sn negative electrode active material with the carbon negative electrode active material may be a weight ratio of about 1:99 to about 90:10.

A content of the negative electrode active material in the negative electrode active material layer may be about 95 wt % to about 99 wt % based on a total weight of the negative electrode active material layer.

In an implementation, the negative electrode active material layer may further include the binder and may optionally include the conductive material. A content of the binder in the negative electrode active material layer may be about 1 wt % to about 5 wt % based on a total weight of the electrode active material layer. In an implementation, the negative electrode active material layer may include about 90 wt % to about 98 wt % of the negative electrode active material, about 1 wt % to about 5 wt % of the binder, and about 1 wt % to about 5 wt % of the conductive material.

The binder may serve to well adhere the negative electrode active material particles to each other and also to adhere the negative electrode active material to the current collector. The binder may include a water-insoluble binder, a water-soluble binder, or a combination thereof.

The water-insoluble binder may include, e.g., polyvinylchloride, carboxylated polyvinylchloride, polyvinylfluoride, an ethylene oxide-containing polymer, ethylene propylene copolymer, polystyrene, polyvinylpyrrolidone, polyurethane, polytetrafluoroethylene, polyvinylidene fluoride, polyethylene, polypropylene, polyamideimide, polyimide, or a combination thereof.

The water-soluble binder may be a rubber binder or a polymer resin binder. The rubber binder may include a styrene-butadiene rubber, an acrylated styrene-butadiene rubber, an acrylonitrile-butadiene rubber, an acryl rubber, a butyl rubber, a fluorine rubber, or a combination thereof. The polymer resin binder may include polyethyleneoxide, polyvinylpyrrolidone, polyepichlorohydrin, polyphosphazene, polyacrylonitrile, ethylenepropylenedienecopolymer, polyvinylpyridine, chlorosulfonatedpolyethylene, latex, a polyester resin, an acrylic resin, a phenol resin, an epoxy resin, polyvinyl alcohol, or a combination thereof.

In an implementation, a water-soluble binder may be used as the negative electrode layer binder, a thickener capable of imparting viscosity may be used together, and the thickener may include, e.g., a cellulose compound. The cellulose compound may include carboxymethyl cellulose, hydroxypropylmethyl cellulose, methyl cellulose, an alkali metal salt thereof, or a combination thereof. The alkali metal may be Na, K, or Li. An amount of the thickener used may be about 0.1 parts by weight to about 3 parts by weight based on 100 parts by weight of the negative electrode active material.

The conductive material may be included to impart conductivity to the electrode, and may include, e.g., a carbon material such as natural graphite, artificial graphite, carbon black, acetylene black, ketjen black, a carbon fiber, a carbon nanotube, or the like; a metal material of a metal powder or a metal fiber including copper, nickel, aluminum, silver, or the like; a conductive polymer such as a polyphenylene derivative; or a mixture thereof.

The negative current collector may include a copper foil, a nickel foil, a stainless steel foil, a titanium foil, a nickel foam, a copper foam, a polymer substrate coated with a conductive metal, or a combination thereof.

In an implementation, the negative electrode layer may be a precipitation-type negative electrode layer. The precipitation-type negative electrode layer may be a negative electrode layer which has no negative electrode active material during the assembly of a battery but in which a lithium metal and the like are precipitated during the charge of the battery and serve as a negative electrode active material.

FIG. 7 is a schematic cross-sectional view including the precipitation-type negative electrode layer. Referring to FIG. 7, the precipitation-type negative electrode layer 400′ may include a negative electrode current collector 401 and a negative electrode coating layer 405 on the negative electrode current collector 401. The all-solid-state battery having this precipitation-type negative electrode layer 400′ may start to be initially charged in absence of a negative electrode active material, and a lithium metal with high density or the like may be precipitated between the negative electrode current collector 401 and the negative electrode coating layer 405 during the charge and form a lithium metal layer 404, which may work as a negative electrode active material. In an implementation, the precipitation-type negative electrode layer 400′, in the all-solid-state battery which is more than once charged, may include the negative electrode current collector 401, the lithium metal layer 404 on the negative electrode current collector 401, and the negative electrode coating layer 405 on the lithium metal layer 404. The lithium metal layer 404 means a layer of the lithium metal and the like precipitated during the charge of the battery and may be called to be a metal layer, a negative electrode active material layer, or the like.

The negative electrode coating layer 405 may include a metal that acts as a catalyst, a carbon material, or a combination thereof.

The metal may include, e.g., gold, platinum, palladium, silicon, silver, aluminum, bismuth, tin, zinc, or a combination thereof, and may be composed of one of these or various types of alloys. When the metal exists in particle form, its average particle diameter (D₅₀) may be less than or equal to about 4 μm or for example, about 10 nm to about 4 μm.

The carbon material may be, e.g., crystalline carbon, amorphous carbon, or a combination thereof. The crystalline carbon may be, e.g., natural graphite, artificial graphite, mesophase carbon microbeads, or a combination thereof. The amorphous carbon may be, e.g., carbon black, activated carbon, acetylene black, denka black, ketjen black, or a combination thereof.

In an implementation, the negative electrode coating layer 405 may include the metal and the carbon material, and the metal and the carbon material may be, e.g., mixed in a weight ratio of about 1:10 to about 2:1. Herein, the precipitation of the lithium metal may be effectively promoted and improve characteristics of the all-solid-state battery. The negative electrode coating layer 405 may include, e.g., a carbon material on which a catalyst metal is supported or a mixture of metal particles and carbon material particles.

The negative electrode coating layer 405 may include, e.g., the metal and amorphous carbon, and in this case, the deposition of lithium metal may be effectively promoted.

The negative electrode coating layer 405 may further include the binder and the binder may be the conductive binder. In an implementation, the negative electrode coating layer 405 may further include additives, e.g., a filler, a dispersant, or an ionic conductive agent.

A thickness of the negative electrode coating layer 405 may be, e.g., about 100 nm to about 20 μm, about 500 nm to about 10 μm, or about 1 μm to about 5 μm.

The precipitation-type negative electrode layer 400′ may further include a thin film, e.g., on the surface of the current collector or between the current collector and the negative electrode catalyst layer. The thin film may include an element capable of forming an alloy with lithium. The element capable of forming an alloy with lithium may be, e.g., gold, silver, zinc, tin, indium, silicon, aluminum, bismuth, and the like, which may be used alone or an alloy of more than one. The thin film may further planarize a precipitation shape of the lithium metal layer 404 and may help improve characteristics of the all-solid-state battery. The thin film may be formed by, e.g., vacuum deposition, sputtering, or plating methods. A thickness of the thin film may be, e.g., about 1 nm to about 500 nm.

The all-solid-state rechargeable battery may be a unit cell having a structure of a positive electrode layer/solid electrolyte membrane/negative electrode layer, a bicell having a structure of a negative electrode layer/solid electrolyte membrane/positive electrode layer/solid electrolyte membrane/negative electrode layer, or a stacked battery in which the unit battery structure is repeated.

In an implementation, the shape of the all-solid-state rechargeable battery may be, e.g., coin-shaped, button-shaped, sheet-shaped, stacked-shaped, cylindrical, flat, or the like. In an implementation, the all-solid-state battery may also be applied to large batteries used in electric vehicles, or the like. In an implementation, the all-solid-state rechargeable battery may also be used in hybrid vehicles such as plug-in hybrid electric vehicles (PHEV). In an implementation, it may be used in a field requiring a large amount of power storage, and may be used, e.g., in an electric bicycle or a power tool.

The following Examples and Comparative Examples are provided in order to highlight characteristics of one or more embodiments, but it will be understood that the Examples and Comparative Examples are not to be construed as limiting the scope of the embodiments, nor are the Comparative Examples to be construed as being outside the scope of the embodiments. Further, it will be understood that the embodiments are not limited to the particular details described in the Examples and Comparative Examples.

### Example 1

### (1)Preparation of Composite

Needle-shaped artificial graphite with an aspect ratio: 4.0, a minor axis length: 1 μm, and a major axis length: 4 μm as diamagnetic core particles, a PVDF binder (#9300, Kureha Inc.) as an insulating material, and a mixture of Li₂S, P₂S₅, and LiCl in a molar ratio of 5:1:2 as a solid electrolyte raw material were prepared.

20 wt % of the needle-shaped artificial graphite was added to the solution prepared by dissolving the PVDF binder at 8 wt % in a solvent of NMP and then, magnetically stirred for 1 hour, filtered, and dried at 120° C. to obtain the needle-shaped artificial graphite coated with the PVDF binder as a precursor. Subsequently, the solid electrolyte raw material and the precursor were mixed in a weight ratio of 30:1 in an acetonitrile solvent and then, magnetically stirred for 2 hours and dried at 120° C. and heat-treated to 400° C. A composite consisting of the needle-shaped artificial graphite core; the PVDF binder layer surrounding the core; and a Li₆PS₅Cl layer surrounding the PVDF binder layer was obtained.

### (2)Preparation of Slurry for Forming Electrolyte Membrane

20 wt % of the composite, 78.3 wt % of Li₆PS₅Cl solid electrolyte (D₅₀₌₃ μm) which is an argyrodite-type crystal, 1.3 wt % of an acryl binder (SX-A334, Zeon Co., Ltd), and 0.4 wt % of a dispersant (H—NBR) were added to a solvent of octyl acetate and then, mixed with a Thinky mixer to prepare slurry for forming an electrolyte membrane.

### (3)Preparation of Solid Electrolyte Membrane

The prepared slurry was coated on a non-woven fabric with a bar coater, and then, a magnetic field with intensity of 1 T was applied thereto for 2 minutes at 25° C. After applying the magnetic field, the slurry was dried in a convection oven at 50° C. for 5 minutes to obtain a stack. The obtained stack was dried at 40° C. in a vacuum oven for 10 hours. Through the above process, a solid electrolyte membrane was manufactured. After preparing the obtained solid electrolyte membrane into a cross-section specimen to examine its cross-section by capturing an image with SEM, 10 composites were selected therefrom to measure a thickness of a shell and an insulating layer of each composite and calculate their average. The shell had an average thickness of 0.5 μm, and the insulating layer had an average thickness of 0.1 μm.

### (4) Manufacture of Positive Electrode Layer

13.5 wt % of a Li₆PS₅Cl solid electrolyte (D₅₀=1 μm), which is an argyrodite-type crystal, 85 wt % of a positive electrode active material (LiNi_{0.8}Co_{0.1}Al_{0.1}O₂), 1.0 wt % of a PVDF binder, and 0.5 wt % of a carbon nanotube conductive material were mixed to prepare positive electrode slurry. The positive electrode slurry was coated on one surface of an aluminum foil positive electrode current collector and then dried and compressed to manufacture a positive electrode layer.

### (5) Manufacture of Negative Electrode Layer

A 12.5 μm-thick nickel foil was prepared as a negative current collector. In addition, carbon black (CB) with a D₅₀ particle diameter of about 30 nm and silver (Ag) particles with a D₅₀ particle diameter of about 60 nm were prepared as a material for forming a negative electrode coating layer.

The carbon black (CB) and the silver (Ag) particles were mixed in a weight ratio of 3:1 to obtain composite powder, 0.25 g of the composite powder was added to a container, and 2 g of an NMP solution including 7 wt % of a PVDF binder (#9300, Kureha Inc.) was added thereto to prepare a mixed solution. The mixed solution was stirred, while NMP was little by little added thereto, to prepare slurry. The prepared slurry was coated on the nickel foil current collector with a bar coater and dried at 80° C. in a convection oven for 10 minutes to obtain a stack. The obtained stack was vacuum-dried at 100° C. for 10 hours, and through the above process, a negative electrode layer having a negative electrode coating layer on the negative current collector was obtained.

(6) Manufacture of all-Solid-State Rechargeable Battery

The solid electrolyte membrane was disposed between the positive electrode layer and the negative electrode layer to prepare a stack. The obtained stack was hot plate-pressed at a pressure of 500 MPa at 80° C. for 30 minutes to manufacture an all-solid-state rechargeable battery cell. Through this pressure treatment, the solid electrolyte membrane was sintered, improving battery characteristics. The pressurized positive electrode active material layer had a thickness of about 105 μm, the negative electrode coating layer had a thickness of 8 μm, and the solid electrolyte membrane had a thickness of 62 μm.

### Comparative Example 1

A solid electrolyte membrane and an all-solid-state rechargeable battery cell were manufactured substantially in the same manner as in Example 1, except that a slurry for forming an electrolyte membrane was prepared without adding the composite and by mixing only 97.5 wt % of a Li₆PS₅Cl solid electrolyte (D₅₀=3 μm), 2 wt % of an acryl binder (SX-A334, Zeon Co., Ltd), and 0.5 wt % of a dispersant (H—NBR) with a Thinky mixer.

### Comparative Example 2

A composite, a solid electrolyte membrane, and an all-solid-state rechargeable battery cell were manufactured substantially in the same manner as in Example 1, except that the composite was prepared by replacing the needle-shaped artificial graphite with spherical shape artificial graphite having an aspect ratio: 1.0, a minor axis length: 3.5 μm, and a major axis length: 3.5 μm to have a diamagnetic core particle and a solid electrolyte shell surrounding the core without forming the insulating layer.

### Comparative Example 3

A composite, a solid electrolyte membrane, and an all-solid-state rechargeable battery cell were manufactured in the same manner as in Example 1, except that the composite was prepared to have a diamagnetic core particle and a solid electrolyte shell surrounding the core without forming the insulating layer.

For each structure of the solid electrolytes (or composites) of Example 1 and Comparative Examples 1 to 3; a core shape, an aspect ratio, a minor axis length, and a minor axis length are shown in Table 1.

TABLE 1

| | | Core | | | |
|---|---|---|---|---|---|
| | Structure of | | | Minor | Major |
| | composite in solid | | Aspect | axis | axis |
| | electrolyte membrane | Shape | ratio | length | length |
| Example 1 | diamagnetic core particle- | needle- | 4.0 | 1 μm | 4 μm |
| | insulating layer-solid | shaped | | | |
| | electrolyte shell | | | | |
| Comparative | solid electrolyte alone | — | — | — | — |
| Example 1 | | | | | |
| Comparative | diamagnetic core particle- | spherical | 1.0 | 3.5 μm | 3.5 μm |
| Example 2 | solid electrolyte shell | shape | | | |
| Comparative | diamagnetic core particle- | needle- | 4.0 | 1 μm | 4 μm |
| Example 3 | solid electrolyte shell | shaped | | | |

### Evaluation Example 1: Evaluation of Ionic Conductivity

The solid electrolyte membranes of the Example and the Comparative Examples were evaluated with respect to ionic conductivity. Each of the solid electrolyte membranes according to Example 1 and Comparative Examples 1 to 3 was placed in a frame with a diameter of 10 mm and pressed at 350 mPa to mold it into a pellet. The ionic conductivity was measured by coating an indium (In) thin film on both surfaces of the pellet to prepare a sample. The prepared sample was measured with respect to impedance by using a potentiostat, AUTOLAB PGSTAT30(Metrohm Autolab Co. Ltd.) to draw a Nyquist plot, from which the ionic conductivity was measured at 45° C. The results are shown in Table 2.

TABLE 2

| | Ionic conductivity |
|---|---|
| | (mS/cm) (@ 45° C.) |
| Example 1 | 0.44 |
| Comparative Example 1 | 0.34 |
| Comparative Example 2 | 0.31 |
| Comparative Example 3 | 0.40 |

Referring to Table 2, the solid electrolyte membrane of Example 1 exhibited high ionic conductivity, compared with the solid electrolyte membranes of Comparative Examples 1 and 2. In Example 1, the solid electrolyte membrane was manufactured by using a composite including diamagnetic core particles with an aspect ratio of greater than 1. Accordingly, as a magnetic field was applied during the manufacturing process of the solid electrolyte membrane, the composite was aligned within a range of 50° to 130° in a plane direction of the solid electrolyte membrane, which was confirmed by manufacturing a cross-section specimen of the solid electrolyte membrane and taking its image with a scanning electron microscope (SEM) to measure an alignment angle of 10 composites therefrom and calculate an average value thereof. The composite was aligned in the solid electrolyte membrane, and the solid electrolyte membrane of Example 1 exhibited a shortened lithium ion path and high ionic conductivity.

In Comparative Example 1, in which the composite was not included in a solid electrolyte membrane, even though a magnetic field was applied during the manufacturing process of the solid electrolyte membrane, solid electrolyte particles were randomly aligned in the solid electrolyte membrane. In addition, in Comparative Example 2, in which spherical diamagnetic particles were used as a core, even though a magnetic field was applied during the manufacturing process of the solid electrolyte membrane, solid electrolyte particles exhibited no specific alignment in the solid electrolyte membrane and thus no increase in ionic conductivity.

### Evaluation Example 2: Evaluation of High Rate Capability and Short Circuit Occurrence

The all-solid-state rechargeable battery cells of the Example and the Comparative Examples were charged under constant current to 4.25 V at 0.1 C and discharged under constant current to 2.5 V at 0.1 C (first cycle); charged under constant current to 4.25 V at 0.1 C and discharged under constant current to 2.5 V at 0.33 C (second cycle); charged under constant current to 4.25 V at 0.1 C and discharged under constant current to 2.5 V at 0.1 C (third cycle) at 45° C. in a thermostat to evaluate discharge capacity and high rate capability. The discharge capacity and high rate capability at each cycle are shown in Table 2. Herein, the high rate capability was defined according to Equation 5.

$$High rate capability [ \% ] = [ Discharge capacity in the 3 rd cycle ( 1 C rate ) / Discharge capacity in the 1 st cycle ( 0.1 C rate ) ] \times 100 [ \% ] \qquad [ Equation 5 ]$$

In addition, at the above charge and discharge cycles, when no internal short circuit occurred, ‘X’ was given, but when an internal short circuit occurred, ‘O’ was given, and the results are shown in Table 3.

TABLE 3

| | | | | | Whether |
|---|---|---|---|---|---|
| | 0.1 C | 0.33 C | 1 C | High | internal |
| | discharge | discharge | discharge | rate | short |
| | capacity | capacity | capacity | capability | circuit |
| | (mAh/g) | (mAh/g) | (mAh/g) | (%) | occurred |
| Example 1 | 194 | 185 | 173 | 89.2 | X |
| Comparative | 195 | 183 | 168 | 86.2 | X |
| Example 1 | | | | | |
| Comparative | — | — | — | — | O |
| Example 2 | | | | | |
| Comparative | — | — | — | — | O |
| Example 3 | | | | | |

Referring to Table 3, Example 1, compared with Comparative Examples 1 to 3, exhibited excellent high rate capability as well as excellent discharge capacity at each cycle and also, no internal short circuit. Accordingly, the composite according to some embodiments turned out to improve high rate capability of all-solid-state rechargeable battery cells and have an effect of suppressing the internal short circuit.

By way of summation and review, some lithium ion batteries may use an electrolyte solution, which includes a flammable organic dispersive medium, and if a short circuit occurs inside the batteries, overheating or fire could occur. Accordingly, all-solid rechargeable batteries may use a solid electrolyte instead of an electrolyte solution.

One or more embodiments may provide a solid electrolyte membrane and an all-solid rechargeable battery that may help improve high rate capability while improving ionic conductivity.

The solid electrolyte membrane according to some embodiments may help shorten the movement path of lithium ions within the electrolyte membrane and reduce the interfacial contact resistance between electrolytes.

The all-solid-state rechargeable battery according to some embodiments may have improved ionic conductivity and improved high rate capability.

Example embodiments have been disclosed herein, and although specific terms are employed, they are used and are to be interpreted in a generic and descriptive sense only and not for purposes of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A solid electrolyte membrane, comprising:
a composite; and
a solid electrolyte,
wherein the composite comprises:
a diamagnetic core particle;
an insulating layer surrounding the diamagnetic core particle; and
a shell surrounding the insulating layer, the shell comprising a solid electrolyte material.

2. The solid electrolyte membrane as claimed in claim 1, wherein the diamagnetic core particle has an aspect ratio, as calculated by Equation 1, of greater than about 1:
Aspect ratio=major axis length/minor axis length. [Equation 1]

3. The solid electrolyte membrane as claimed in claim 2, wherein a major axis of the diamagnetic core particle is arranged to be about 50° to about 130° with respect to a plane of the solid electrolyte membrane.

4. The solid electrolyte membrane as claimed in claim 1, wherein the diamagnetic core particle is needle-shaped, plate-shaped, or oval-shaped.

5. The solid electrolyte membrane as claimed in claim 1, wherein:
the diamagnetic core particle comprises a carbon material, and
the carbon material comprises artificial graphite, natural graphite, graphene, a carbon nanotube (CNT), an L-carbon nanotube (long length CNT), a carbon fiber, carbon black, or a combination thereof.

6. The solid electrolyte membrane as claimed in claim 1, wherein the insulating layer comprises a polymer, the polymer including polyethylene oxide, a hydrogenated nitrile rubber, a styrene-butadiene rubber, polyvinylidene fluoride, or a combination thereof.

7. The solid electrolyte membrane as claimed in claim 1, wherein a weight ratio of the diamagnetic core particle and the insulating layer is about 1:0.01 to about 1:50.

8. The solid electrolyte membrane as claimed in claim 1, wherein the solid electrolyte material of the shell comprises a sulfide solid electrolyte material, an oxide solid electrolyte material, a halide solid electrolyte material, or a combination thereof.

9. The solid electrolyte membrane as claimed in claim 1, wherein a weight ratio of the diamagnetic core particle and the shell is about 1:1 to about 1:500.

10. The solid electrolyte membrane as claimed in claim 1, wherein:
a major axis length of the diamagnetic core particle is about 1 μm to about 50 μm and
a minor axis length of the diamagnetic core particle is about 0.01 μm to about 5 μm.

11. The solid electrolyte membrane as claimed in claim 1, wherein the composite is included in the solid electrolyte membrane in an amount of about 0.1 wt % to about 5 wt %, based on a total weight of the solid electrolyte membrane.

12. The solid electrolyte membrane as claimed in claim 1, wherein the solid electrolyte of the solid electrolyte membrane:
comprises a sulfide solid electrolyte, an oxide solid electrolyte, a halide solid electrolyte, or a combination thereof,
is in a form of particles, and
has an average particle diameter (D₅₀) of about 0.1 μm to about 5.0 μm.

13. A method of preparing a solid electrolyte membrane, the method comprising:
obtaining a composite that comprises a diamagnetic core particle, an insulating layer surrounding the diamagnetic core particle, and a shell surrounding the insulating layer, the shell comprising a solid electrolyte,
preparing a slurry for forming an electrolyte membrane such that the slurry for forming an electrolyte membrane comprises the composite and a solid electrolyte, and
coating the slurry for forming the electrolyte membrane on a substrate.

14. The method of preparing the solid electrolyte membrane as claimed in claim 13, further comprising applying a magnetic field to the slurry for forming an electrolyte membrane coated on the substrate.

15. The method of preparing the solid electrolyte membrane as claimed in claim 14, wherein:
a strength of the magnetic field is about 0.1 T to about 3 T, and
an application time of the magnetic field is about 0.1 second to about 10 minutes.

16. The method of preparing the solid electrolyte membrane as claimed in claim 14, further comprising drying the slurry for forming an electrolyte membrane after the magnetic field is applied to form the solid electrolyte membrane.

17. The method of preparing the solid electrolyte membrane as claimed in claim 13, wherein obtaining the composite comprises:
mixing diamagnetic particles and an insulating material in a first solvent followed by performing a first drying,
mixing a resultant of the first drying and a solid electrolyte raw material in a second solvent followed by performing a second drying, and
heat treating the resultant of the second drying.

18. The method of preparing the solid electrolyte membrane as claimed in claim 17, wherein the slurry for forming the solid electrolyte membrane is prepared by mixing the composite, a solid electrolyte, and a third solvent.

19. The method of preparing the solid electrolyte membrane as claimed in claim 17, wherein the first drying is performed at about 80° C. to about 150° C.

20. The method of preparing the solid electrolyte membrane as claimed in claim 17, wherein the second drying is performed at about 80° C. to about 150° C.

21. The method of preparing the solid electrolyte membrane as claimed in claim 17, wherein the heat treatment is performed at about 200° C. to about 600° C.

22. An all-solid-state rechargeable battery, comprising:
a positive electrode layer;
a negative electrode layer; and
the solid electrolyte membrane as claimed in claim 1 between the positive electrode layer and the negative electrode layer.
